(19) United States
(12) Patent Application Publication
(10) Pub. No.: US 2007/0139398 A1
(43) Pub. Date: Jun. 21, 2007

(54) Collapsible stylus

(76) Inventors: Martin E. Holman IV, Boca Raton, FL (US); Douglas W. Moskowitz, Weston, FL (US); Oscar J. Pichardo, Parkland, FL (US)

Correspondence Address: MOTOROLA INC, 600 NORTH US HIGHWAY 45, ROOM AS437, LIBERTYVILLE, IL, 60048-5343, US

(21) Appl. No.: 11/313,318

(22) Filed: Dec. 21, 2005

(51) Int. Cl. G09G 5/00

(52) U.S. Cl. 345/179

(57) ABSTRACT

A collapsible stylus (100) is disclosed, which includes at least one spring (202) and a plurality of body panels (204). The at least one spring can be placed along a longitudinal axis of the collapsible stylus. The plurality of body panels can envelope the at least one spring. The plurality of body panels can be forced into an expanded state by the at least one spring in the absence of an external force. Further, the plurality of panels can be compressed into a collapsed state on the application of external force.

### FIELD OF THE DISCLOSURE

This disclosure relates to electronic device accessories, and more specifically, it relates to stylus for the electronic devices.

### BACKGROUND

Many hand-held electronic devices such as smart phones, personal digital assistants (PDAs), pagers and personal organizers have touch screens, which act as display devices as well as input devices. A touch screen includes controlling icons such as a menu, options, programs, and other operations. The controlling icons can be touched on the touch screen to input information. A stylus can be used to select icons and provide other inputs on the touch screen.

The stylus is a hand-held instrument with a pointed end, which comes in contact with the touch screen. Styli are available in a variety of shapes and sizes. Exemplary shapes include circular, oval, square, flat, and so forth. Generally, the stylus is stowed in the hand-held device, and therefore, needs some extra space inside the device. This extra space may increase the size of the device and may also make it less attractive aesthetically. Thus, there is a need for a stylus that has a size large enough to be comfortable for holding, and further takes less space to stow in a hand-held device.

### SUMMARY

The collapsible stylus can include at least one spring and a plurality of body panels. This one spring can be placed along a longitudinal axis of the collapsible stylus. The longitudinal axis can be parallel to the length of the collapsible stylus. The plurality of body panels can envelop at least this one spring. The plurality of body panels can be forced into an expanded state by at least this one spring in the absence of an external force and can be compressed to a collapsed state on application of the external force.

The disclosure can provide an electronic device having a collapsible stylus and a housing. The collapsible stylus can include at least one spring, and a plurality of body panels. The plurality of body panels can envelop the at least this one spring. This one spring can be placed along a longitudinal axis of the collapsible stylus. The longitudinal axis can be parallel to a length of the collapsible stylus. The at least this one spring can exert an internal force along a transverse axis. The transverse axis can be the axis perpendicular to the longitudinal axis of the collapsible stylus. The plurality of body panels can be forced to an expanded state by the at least this one spring in the absence of an external force. The plurality of body panels further can be compressed to a collapsed state on the application of the external force. Further, the housing can include a channel for inserting the collapsible stylus. The channel can exert the external force on the collapsible stylus in the transverse axis to compress the collapsible stylus to the collapsed state.

The disclosure can further provide a method for manufacturing a collapsible stylus having at least one spring and a plurality of body panels. The method can include, insert-molding a pointer and an end cap on a first end and a second end of the at least one spring to form a spring assembly, and enveloping the plurality of body panels around the spring assembly. The plurality of body panels can be connected to each other by inserting pins. The plurality of body panels can be connected to each other such that body panels are capable of rotating relative to each other.

### BRIEF DESCRIPTION OF THE FIGURES

The disclosure is illustrated by way of example, and not limitation, in the accompanying figures, in which like references indicate similar elements, and in which:

FIG. 1 illustrates a collapsible stylus, in accordance with an embodiment;

FIG. 2 illustrates an exploded view of the collapsible stylus, in accordance with an embodiment;

FIG. 3 illustrates a first cross-sectional view of the collapsible stylus in its expanded state, in accordance with an embodiment;

FIG. 4 illustrates a second cross-sectional view of the collapsible stylus in its expanded state, in accordance with an embodiment;

FIG. 5 illustrates a cross-sectional view of the collapsible stylus in its collapsed state, in accordance with an embodiment;

FIG. 6 illustrates an electronic device with a channel for stowing the collapsible stylus, in accordance with an embodiment;

FIG. 7 illustrates a spring, in accordance with an embodiment;

FIG. 8 illustrates a body panel, in accordance with an embodiment; and

FIG. 9 is a flowchart illustrating a method for manufacturing the collapsible stylus, in accordance with an embodiment.

### DETAILED DESCRIPTION

Before describing the collapsible stylus in detail, it should be observed that the disclosure describes combinations of apparatus components related to the collapsible stylus. Accordingly, the apparatus components have been represented where appropriate by conventional symbols in the drawings, showing only those specific details that are pertinent to understanding the disclosure so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The term “another”, as used herein, is defined as at least a second or more. The terms “including” and/or “having”, as used herein, are defined as comprising.

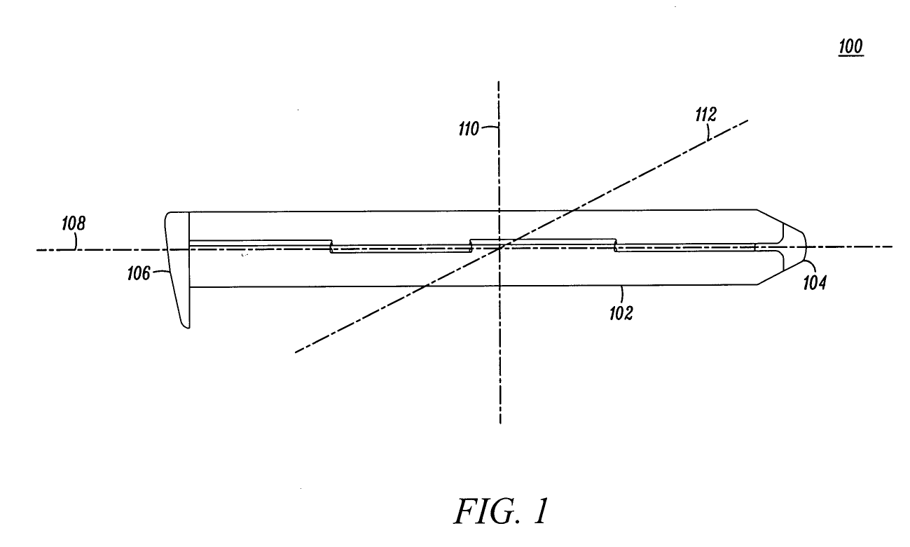

FIG. 1 illustrates a collapsible stylus 100, in accordance with an embodiment. The collapsible stylus 100 includes a body 102, a pointer 104, and an end cap 106. The body 102 can include at least one spring and a plurality of body panels. The least one spring can apply an internal force on the plurality of body panels, keeping the collapsible stylus 100 in an expanded state in absence of an external force. The body 102 is described in detail in conjunction with the subsequent figures. The pointer 104 is attached at a first end of the collapsible stylus 100 and can be in contact with a touch screen while writing. The end cap 106 can be plugged into the collapsible stylus 100 at a second end. The end cap 106 can be used to increases the aesthetic value of the collapsible stylus 100.

The collapsible stylus 100 has a longitudinal axis 108, a transverse axis 110, and a radial axis 112, in accordance with various embodiments. The longitudinal axis 108 can be an axis that is parallel to the length of the collapsible stylus 100. The transverse axis 110 can be perpendicular to the longitudinal axis 108. Further, the radial axis 112 can be perpendicular to the longitudinal axis 108 and the transverse axis 110, as illustrated in FIG. 1.

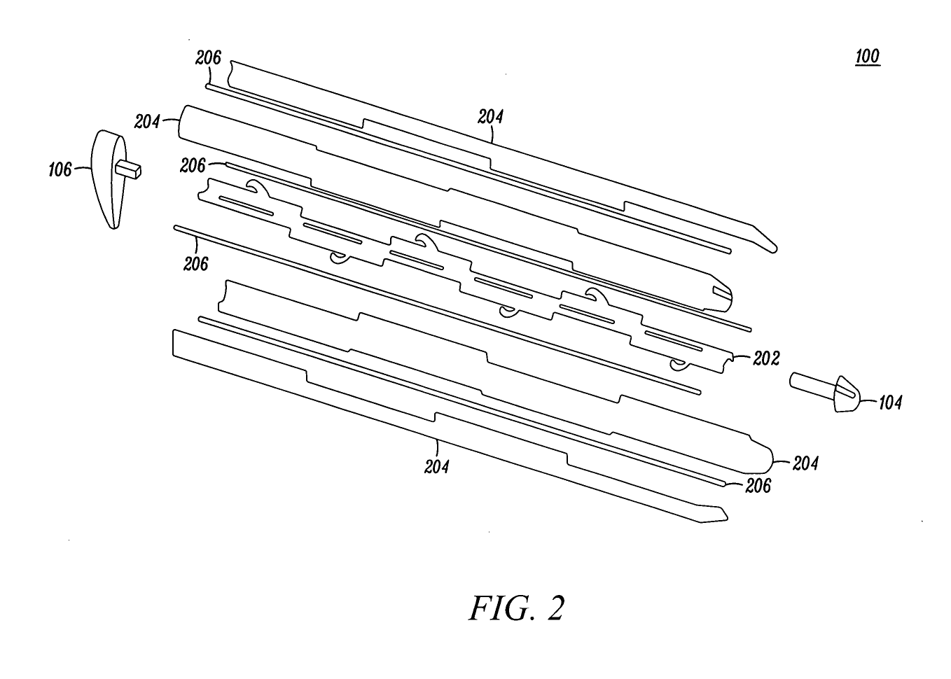

FIG. 2 illustrates an exploded view of the collapsible stylus 100, in accordance with an embodiment. The collapsible stylus 100 includes at least one spring 202, a plurality of body panels 204, a plurality of pins 206, the pointer 104, and the end cap 106. The at least one spring 202 is placed along the longitudinal axis 108 of the collapsible stylus 100. The plurality of body panels 204 envelopes the at least one spring 202. In an embodiment, there are four body panels enveloping at least one spring. The body panels 204 are coupled to each other, using the plurality of pins 206 to form couplings. The plurality of body panels 204 are coupled to each-other such that they are capable of rotating with respect to each other around the coupling.

In an embodiment, the at least one spring 202 includes a base member and a plurality of leaf members. The plurality of leaf members is in contact with at least one coupling between the plurality of body panels 204. The plurality of leaf members exerts a radially outward force on the plurality of body panels 204, forcing the collapsible stylus 100 into an expanded state. The radially outward force has also been referred to as an internal force, in accordance with various embodiments. In the expanded state, the collapsible stylus 100 acquires a substantially round or oval shape, such that it is easy to hold in hand for writing purpose. The plurality of body panels 204 can be compressed into a collapsed state on the application of external force in a direction opposite to the internal force. The collapsible stylus 100 can be stowed in an electronic device in the collapsed state, as this reduces the space required to store the collapsible stylus 100 in the electronic device.

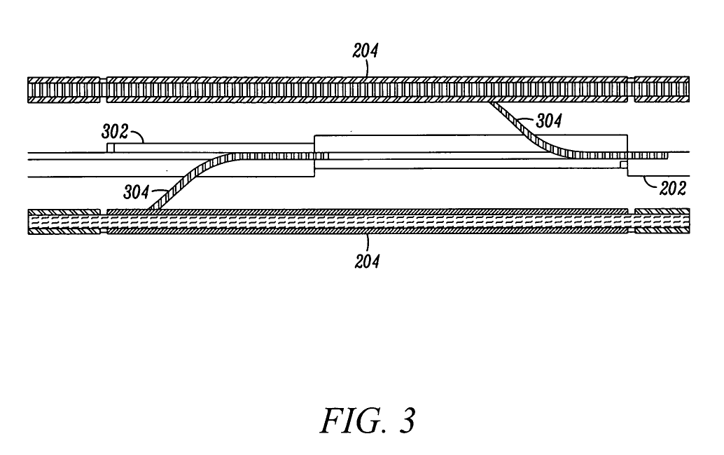

FIG. 3 illustrates a first cross-sectional view of the collapsible stylus 100 in its expanded state, in accordance with an embodiment. The first cross-sectional view illustrates the spring 202 and the plurality of body panels 204. The spring 202 includes a base member 302 and a plurality of leaf members 304. The plurality of leaf members 304 is an extended part of the base member 302, in accordance with an embodiment. They are attached at one end to the base member 302 and coupled at the other, to the plurality of body panels 204. The plurality of leaf members 304 exerts a radially outward force on the plurality of body panels 204, forcing the body 102 into the expanded state.

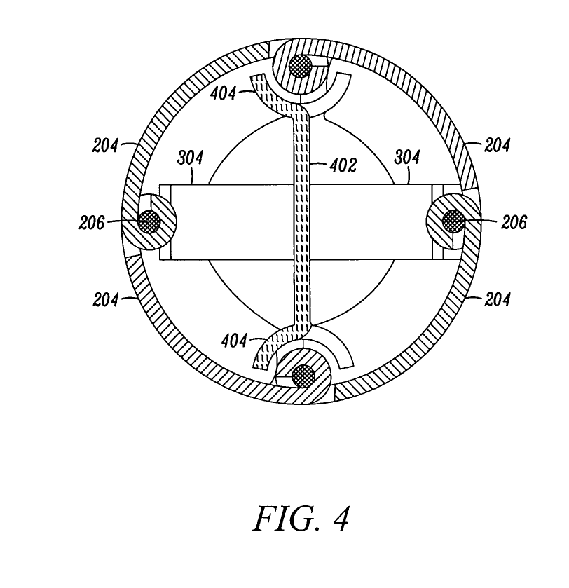

FIG. 4 illustrates a second cross-sectional view of the collapsible stylus 100 in its expanded state, in accordance with an embodiment. Each body panel 204 is connected on each side to a second body panel 204, using the pin 206 to form a coupling. This enables the plurality of body panels 204 to rotate relative to each other. Further, each of the plurality of leaf members 304 is connected to at least one of the couplings. The plurality of leaf members 304 exerts outward force on the couplings, forcing the collapsible stylus 100 into the expanded state.

In an embodiment, the base member 302 includes a plurality of supporting sections placed along the radial axis 112. The plurality of supporting sections provides support to a diametrically opposite pair of couplings. This enables the collapsible stylus 100 to acquire the desirable round or oval shape in the expanded state. Each of the plurality of supporting section includes an arm 402 and a semicircular end 404. The arm 402 extends along an axis that is perpendicular to the longitudinal axis 108 and perpendicular to the transverse axis 110. The arm 402 includes an end at a distal end of the arm 402 from the longitudinal axis 108. The semicircular end 404 is coupled to the end of the arm 402. The diametrically opposite pair of couplings is supported by the semicircular end 404, in accordance with an embodiment. The support prevents the collapsible stylus 100 to collapse along the radial axis 112.

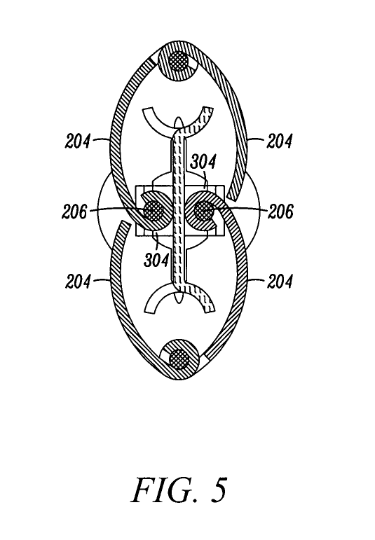

FIG. 5 illustrates a cross-sectional view of the collapsible stylus 100 in the collapsed state, in accordance with an embodiment. In the collapsed state, the plurality of body panels 204 gets compressed or flattened. This reduces the space required for stowing the collapsible stylus 100 in the electronic device. Thus, the collapsible stylus 100 and a respective slot can be provided in an electronic device when there is more space available in one direction than another. For example, the thickness of an electronic device can be reduced along one axis because the collapsible stylus 100 can take up less space along that axis.

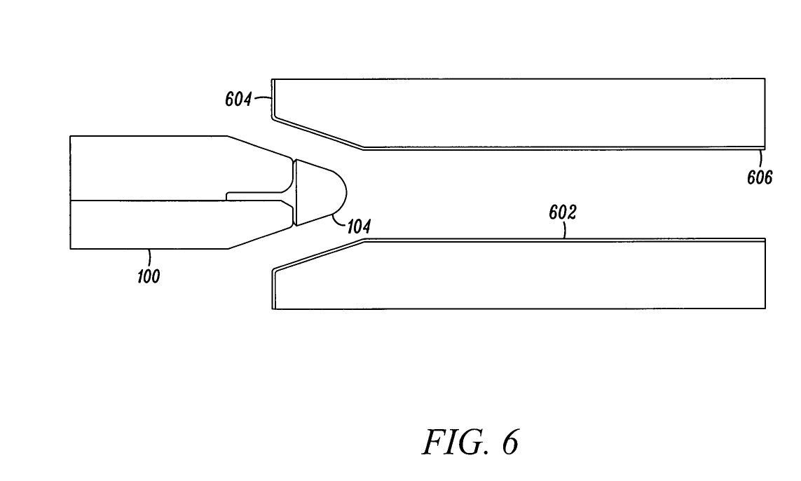

The electronic device stowing the collapsible stylus 100 is described in conjunction with FIG. 6. The collapsible stylus 100 attains the collapsed state on the application of an external force. This external force can be applied on the collapsible stylus 100 along the transverse axis 110, in a direction that is opposite to that of the radially outward force applied by the plurality of leaf members 304. In the collapsed state, the collapsible stylus 100 can be compressed by 30 percent to 70 percent of its thickness in its expanded state. In another embodiment, the collapsible stylus 100 can be compressed to about 50 percent. In an exemplary embodiment, the plurality of leaf members 304 are flattened in their collapsed state, so that a pair of diametrically opposite couplings collapses to touch the base member 302, as illustrated in the figure. Further, the second pair of diametrically opposite couplings moves away from the supporting sections. In an embodiment, the external force, applied by an external source to compress the collapsible stylus 100, is more than the force applied by a user to comfortably grip the collapsible stylus 100. The plurality of body panels 204 can be forced to an expanded state by the spring 202, in the absence of the external force.

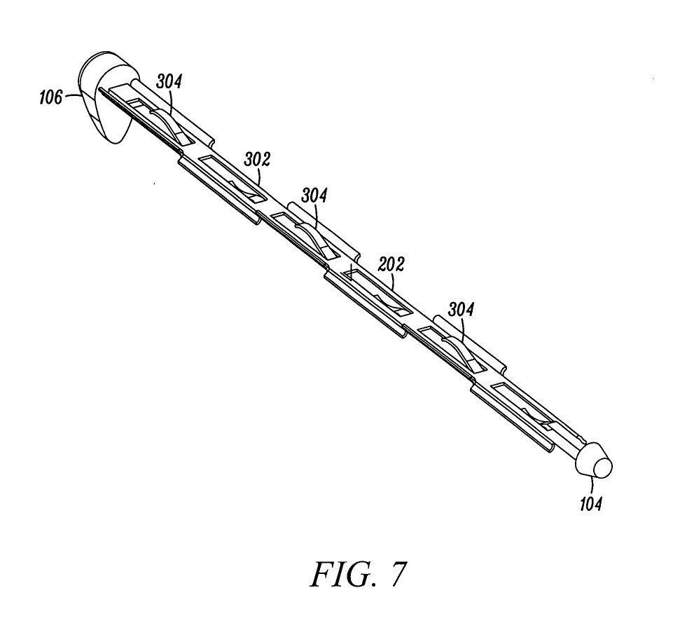

FIG. 6 illustrates an electronic device with a channel 602 for stowing the collapsible stylus 100, in accordance with an embodiment. The channel 602 includes a first end 604 and a second end 606. The collapsible stylus 100 is inserted from the first end 604, which can have various profiles for easing the process of inserting the collapsible stylus 100. In an embodiment, the first end 604 is tapered from broad to narrow along the length of the channel 602. The channel 602 can have an elliptical profile, so that when the collapsible stylus 100 is inserted, an external force acts on the body 102 in a direction that is opposite to that of the force applied by the spring 202. The spring 202 is described in detail in conjunction with FIG. 7. Hence, as the spring 202 collapses, the plurality of leaf members 304 are flatted, and the collapsible stylus 100 is forced into a collapsed state. In an embodiment, the collapsible stylus 100 is substantially flattened in the collapsed state, thereby reducing the space requirement for stowing.

FIG. 7 illustrates the spring 202, in accordance with an embodiment. The spring 202 includes the base member 302, and the plurality of leaf members 304. The spring 202 can be formed from sheet metal, plastic, and the like. Various metals and alloys can be also used to manufacture the spring 202. Some examples of these metals and alloys, which can be used to manufacture the spring 202, include but are not limited to stainless steel, various alloys of steel, and so forth. The pointer 104 and the end cap 106 can be plugged to the ends of the spring 202 by insert molding. The pointer 104 and end cap 106 may also be attached to the ends of the spring 202 using adhesives, snaps, or any other means for attaching a pointer and end cap to a device. The pointer 104 and the end cap 106 can be made of various polymers. Some examples of material for manufacturing the pointer 104 and the end cap 106 includes, but is not limited to, poly-carbon, nylon, and so forth. The spring 202, the pointer 104, and the end cap 106 together forms a spring assembly.

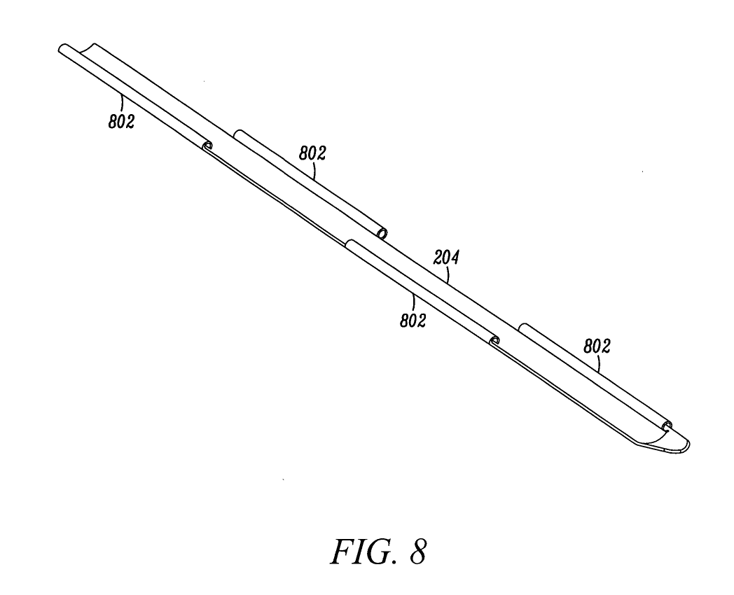

FIG. 8 illustrates a body panel 204, in accordance with an embodiment. The body panel 204 can be formed by using sheet metal, plastic, and the like. Various metals and alloys can also be used to manufacture the body panel 204. Some examples of metals and alloys that can be used to manufacture the body panel 204 include stainless steel, various steel alloys, and so forth. The body panel 204 has panel slots 802 to hold the pin 206. The profile of the panel slots 802 is large enough to insert the pin 206. The panel slots 802 of two adjacent body panels when joined by the pin 206 form a coupling.

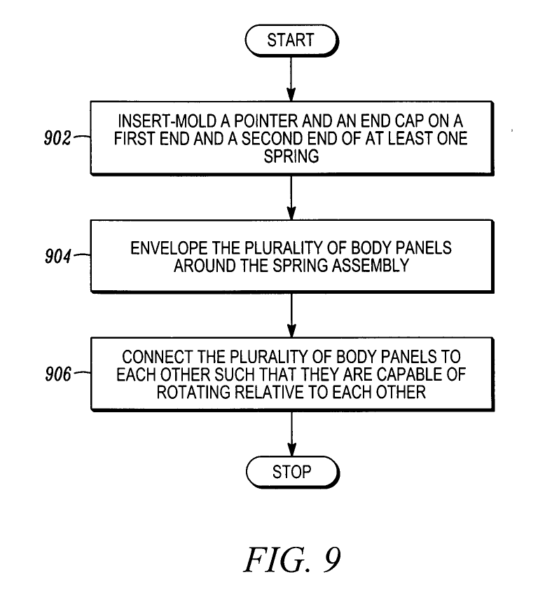

FIG. 9 is a flowchart illustrating a method of manufacturing the collapsible stylus 100, in accordance with an embodiment. At step 902, the pointer 104 and an end cap 106 are insert-molded on a first end and a second end of the spring 202, to form the spring assembly. The first end of the spring 202 is opposite to the second end. At step 904, the plurality of body panels 204 are enveloped around the spring assembly. In an embodiment, the plurality of body panels 204 are connected to each other by using the plurality of pins 206 before enveloping it around the spring assembly. Their point of connection forms a coupling. Further, the plurality of body panels 204 is connected in such a way that at least one pair of body panels remains unconnected, thereby reserving space to insert the spring assembly. At step 906, the at least one pair of body panels is connected by using at least one pin 206.

In an embodiment, the collapsible stylus 100 includes four body panels, namely, a first panel, a second panel, a third panel, and a forth panel, which are connected by using four pins, namely, a first pin, a second pin, a third pin, and a forth pin. The first panel and second panel are connected by inserting the first pin in the panel slots of the first and second panels. Further, the second panel is connected to the third panel by inserting the second pin in the panel slots of the second and third panels. Moreover, the third panel is connected to the fourth panel by inserting the third pin in the panel slots of the third and fourth panels. The four panels are then wrapped around the spring 202, so that the spring 202 lies along the longitudinal axis 108 of the collapsible stylus 100. The fourth pin is then inserted in the panel slots of the first and fourth panels. The collapsible stylus 100 thus manufactured deforms to a collapsed state on the application of external force along the transverse axis 110, and returns to its expanded shape when the external force is removed.

As described above, the collapsible stylus 100 requires less stowing space in its collapsed state, and can therefore be stowed in an electronic device. Further, the collapsible stylus 100 achieves an expanded state that it is convenient to hold and write with it on an input screen of an electronic device when removed from the electronic device.

It is expected that one of ordinary skill, notwithstanding possibly many design choices motivated by, for example, available time, current technology, and economic considerations, when guided by the concepts and principles disclosed herein, will be readily capable of making such a collapsible stylus with minimal experimentation.

In the foregoing specification, a collapsible stylus has been described with reference to specific embodiments. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. A collapsible stylus comprising:
at least one spring, the at least one spring placed along a longitudinal axis of the collapsible stylus, the longitudinal axis being parallel to a length of the collapsible stylus; and
a plurality of body panels, the plurality of body panels enveloping the at least one spring, wherein the plurality of body panels are forced to an expanded state by the at least one spring in the absence of an external force, further the plurality of panels being compressed to a collapsed state on application of the external force.

2. The collapsible stylus according to claim 1 further comprising a plurality of pins for coupling the plurality of panels to each other, such that the plurality of panels are capable of rotating with respect to each other.

3. The collapsible stylus according to claim 1, wherein the at least one spring comprises:
a base member; and
a plurality of leaf members, the plurality of leaf members being extended parts of the base member, the plurality of leaf members exerting force on the plurality of panels in a transverse direction, the transverse direction being perpendicular to the longitudinal axis of the collapsible stylus.

4. The collapsible stylus according to claim 3, wherein the base member comprises a plurality of supporting-sections, the plurality of supporting-sections supporting the plurality of body panels when the collapsible stylus is in the expanded state.

5. The collapsible stylus according to claim 4, wherein each of the plurality of supporting-sections comprises:
an arm extending along an axis perpendicular to the longitudinal axis and perpendicular to the transverse axis, the arm including an end at a distal end of the arm from the longitudinal axis, and
a semicircular end coupled to the end of the arm.

6. The collapsible stylus according to claim 1, wherein the at least one spring is formed out of a sheet metal.

7. The collapsible stylus according to claim 1 further comprising a pointer, the pointer being plugged to a first end of the collapsible stylus.

8. The collapsible stylus according to claim 7 further comprising an end cap, the end cap being plugged to a second end of the collapsible stylus, the second end opposite the first end.

9. The collapsible stylus according to claim 1, wherein the at least one spring is a metal leaf type spring.

10. An electronic device comprising:
a collapsible stylus comprising:
at least one spring placed along a longitudinal axis of the collapsible stylus, the longitudinal axis being parallel to a length of the collapsible stylus, the at least one spring exerting an internal force along a transverse axis, the transverse axis being perpendicular to the longitudinal axis of the collapsible stylus; and
a plurality of body panels enveloping the at least one spring, the plurality of body panels being forced to an expanded state by the at least one spring in the absence of an external force, the plurality of body panels further being compressed to a collapsed state on the application of the external force; and
a housing comprising a channel for inserting the collapsible stylus, the channel exerting the external force on the collapsible stylus in the transverse axis to compress the collapsible stylus to the collapsed state.

11. The electronic device according to claim 10, wherein the collapsible stylus further comprises a plurality of pins for coupling the plurality of body panels to each other, where the plurality of body panels are capable of rotating with respect to each other via the plurality of pins.

12. The electronic device according to claim 10, wherein the at least one spring is a metal leaf type spring.

13. The electronic device according to claim 10, wherein the at least one spring comprises:
a base member; and
a plurality of leaf members, the plurality of leaf members being the extended part of the base member, the plurality of leaf members exerting force on the plurality of panels in the transverse axis.

14. The electronic device according to claim 13, wherein the base member comprises:
a plurality of supporting-sections, the plurality of supporting-sections supporting the plurality of body panels when the collapsible stylus is in the expanded state.

15. The electronic device according to claim 14, wherein each of the plurality of supporting-sections comprises:
an arm extending along an axis perpendicular to the longitudinal axis and perpendicular to the transverse axis, the arm including an end at a distal end of the arm from the longitudinal axis, and
a semicircular end coupled to the end of the arm.

16. The electronic device according to claim 10, wherein the collapsible stylus further comprises a pointer plugged at a first end of the collapsible stylus.

17. The electronic device according to claim 16, wherein the collapsible stylus further comprises an end cap plugged at a second end of the collapsible stylus, the second end opposite the first end.

18. A collapsible stylus comprising at least one spring and a plurality of body panels manufactured by a method comprising:
insert-molding a pointer and an end cap on a first end and a second end of the at least one spring to form a spring assembly, the second end opposite the first end;
enveloping the plurality of body panels around the spring assembly; and
connecting the plurality of body panels to each other by inserting pins, such that the plurality of body panels are connected to each other at least one point, further such that the plurality of body panels are capable of rotating relative to each other.

19. The collapsible stylus according to claims 18, wherein the method for manufacturing the collapsible stylus further comprises forming the at least one spring using a sheet metal.

20. The collapsible stylus according to claim 18, wherein the method for manufacturing the collapsible stylus further comprises forming at least one of the plurality of body panels using a sheet metal.
